(19) United States
(12) Patent Application Publication
(10) Pub. No.: US 2021/0219694 A1
(43) Pub. Date: Jul. 22, 2021

(54) CHILD-PROOF SMART BLOW DRYER

(71) Applicant: Chaoqiang Zhou, Hunan (CN)

(72) Inventor: Chaoqiang Zhou, Hunan (CN)

(21) Appl. No.: 17/055,858

(22) PCT Filed: Apr. 12, 2019
(86) PCT No.: PCT/CN2019/082521

§ 371 Date: Nov. 16, 2020

(30) Foreign Application Priority Data
May 31, 2018 (CN) 201810553017..8

(51) Int. Cl. A45D 20/12; G06T 7/90; G06T 7/194; G06K 9/46

(52) U.S. Cl. CPC A45D 20/12; G06K 9/4604; G06T 7/194; G06T 7/90

(57) ABSTRACT

The present invention relates to a child-proof smart hair dryer, comprising: an AC permanent magnet motor for driving the fan blade structure of the hair dryer to rotate; the fan blade structure, while rotating, forming a centrifugal airflow in the air duct; a hemispherical photographing mechanism, which includes a trailing measurement device, an image capture device, a data analysis device, a DC drive motor, an optical filter, an optical lens, and an image sensing device, wherein the image sensing device is set on the air duct, and is used to take an image of the front of the air duct; a trailing measurement device is used to perform an image content measurement to determine whether a trailing pattern appears in the image in front of the air duct, and sending a content trailing signal when a trailing pattern appears.

### TECHNICAL FIELD

The present invention relates to the field of household equipment, in particular to a child-proof smart hair dryer.

### BACKGROUND ART

A hair dryer is mainly for drying and shaping hair, but it can also be used for partial drying, heating and physical therapy in laboratories, physical therapy rooms, industrial production, and art. It can be divided into AC series type, AC shaded pole type and DC permanent magnet type according to the type of motor it uses. The advantages of series hair dryers are large starting torque and high speed, which are suitable for making hair dryers with high-power. However, its disadvantage is the creation of noise and the commutator has certain interference to telecommunication equipment. The advantages of shaded pole hair dryers are low noise, long life, and no interference to telecommunication equipment. The disadvantages are low rotation speed, poor starting performance, and heavy weight. The advantages of permanent magnet type hair dryers are light weight, high rotation speed, simple manufacturing process, low cost, high quality and low price.

### SUMMARY OF THE INVENTION

In order to solve the technical problem of child-related accidents caused by existing hair dryers, the present invention provides a child-proof smart hair dryer, which performs targeted edge deepening processing of the obtained blocks based on the search results of blocks with large content deviations, thereby improving the efficiency of edge deepening processing. Basing on the processing of white balance processing equipment and morphology processing equipment, the orientation and targeted extraction of the foreground image of the image to be processed are realized, thus providing more valuable data to be analyzed for the recognition and detection of subsequent images. When the trailing phenomenon caused by jitter is detected, the image content is analyzed, specifically, the displacement vector of the image is determined based on each red channel value of each pixel of the image, and adopts the built-in motor of the hemispherical photographing mechanism to perform corresponding displacement correction. Based on the above-mentioned high-precision data processing, when the presence of a child is detected, the AC permanent magnet motor of the hair dryer is turned off in time to avoid related accidents.

According to an aspect of the present invention, a child-proof smart hair dryer is provided, wherein the hair dryer comprises:
an AC permanent magnet motor, used for driving the fan blade structure of the hair dryer to rotate; the fan blade structure, which is arranged between the air inlet of the hair dryer and the front nozzle of the air duct, for sucking in air from the air inlet while rotating, and forming a centrifugal airflow in the air duct to blow it out through the front nozzle of the air duct; a hemispherical photographing mechanism, which includes a trailing measurement device, an image capture device, a data analysis device, a DC drive motor, an optical filter, an optical lens, and an image sensing device, wherein the image sensing device is set on the air duct, and is used to take an image of the front of the air duct.

More specifically, the child-proof smart hair dryer further comprises:
a trailing measurement device, which is connected to the image sensing device, and is used to receive the image in front of the air duct, and performs an image content measurement of the image in front of the air duct to determine whether a trailing pattern appears in the image in front of the air duct, and sending a content trailing signal when a trailing pattern appears, or otherwise, sending a content normal signal; an image capture device, which is respectively connected to the trailing measurement device and the image sensing device, and is used to output the image in front of the air duct corresponding to the first content trailing signal as an image to be analyzed, and outputs the image in front of the air duct closest to the image in front of the air duct corresponding to the first content trailing signal as an image to be compared when the first content trailing signal is received.

More specifically, the child-proof smart hair dryer further comprises:
a data analysis device, which is connected to the image capture device, and is used to receive the image to be analyzed and the image to be compared, and to determine the displacement vector of the image to be compared relative to the image to be analyzed based on the overall comparison between the image to be analyzed and the image to be compared, and outputs as the current displacement vector.

More specifically, the child-proof smart hair dryer further comprises:
a DC drive motor, which is respectively connected to the optical filter, the optical lens, the image sensing device and the data analysis device, and is used to control the optical filter, the optical lens and the image sensing device to move together in an opposite direction basing on the displacement vector.

More specifically, the child-proof smart hair dryer further comprises:
a white balance processing device, which is connected to the hemispherical photographing mechanism, and is used to receive the image in front of the air duct and perform white balance processing on the image in front of the air duct to obtain and outputs a corresponding white balance image; a morphology processing device, which includes an expansion processing sub-device and a corrosion processing sub-device, wherein the expansion processing sub-device is connected to the white balance processing device, and is used to receive the white balance image and performs expansion processing on the white balance image to obtain a corresponding expansion processing image, and the corrosion processing sub-device is connected to the expansion processing sub-device for receiving the expansion processing image and performing corrosion processing on the expansion processing image to obtain the corresponding corrosion processed image; a pixel value statistics device, which is connected to the morphology processing device, and is used to receive the corrosion processed image, obtains each brightness value of each pixel of the corrosion processed image, performs a mean square error calculation on each brightness value, and outputs the obtained mean square error value as reference data; a fragment extraction device, which is connected to the pixel value statistics device, and is used to receive the corrosion processed image and the reference data, and performs uniform segmentation on the corrosion processed image based on the reference data to obtain a plurality of segmented fragments, wherein, the larger the reference data, the larger the number of segmented fragments obtained by uniformly segmenting the corrosion processed image; a noise analysis device, which is connected to the fragment extraction device, and is used to receive the plurality of segmented fragments, and detects the top five noise types of the segmented fragments in amplitude for each segmented fragment, determines the signal-to-noise ratio of the segmented fragments based on the respective amplitude corresponding to the five noise types, and determines the threshold size for background segmentation of the segmented fragments based on the signal-to-noise ratio of the segmented fragments; a foreground extraction device, which is connected to the noise analysis device, and is used to perform background segmentation processing on the segmented fragments based on a determined threshold value to obtain the corresponding foreground fragment for each segmented fragment, and to perform fitting on each foreground fragment of each segmented fragment to obtain a foreground detection image, and outputs the foreground detection image; an edge enhancement device, which is connected to the foreground extraction device, and is used to receive the foreground detection image, and performs edge enhancement processing on the foreground detection image based on the corresponding intensity of the signal-to-noise ratio of the foreground detection image to obtain corresponding adaptive enhanced image, and outputs the adaptive enhanced image; a block searching device, which is connected to the edge enhancement device, and is used to receive the adaptive enhanced image, and performs homogenized block processing on the adaptive enhanced image to obtain each homogenized block, and performs the following operations to each homogenized block: acquiring the average of the brightness value of each pixel of the homogenized block; the block searching device is further used to determine the average of the image-level brightness of the adaptive enhanced image based on each of the average value of each homogenized block, the homogenized block whose absolute value of the difference between the average value and the image-level brightness average exceeds the limit is used as the target homogenized block, and outputs each target homogenized block in the adaptive enhanced image; in the block searching device, a plurality of homogenized blocks except for each target homogenized block in the adaptive enhanced image are used as a plurality of homogenized blocks to be filled, and outputs the plurality of homogenized blocks to be filled; a block deepening device, which is connected to the block searching device, and is used to perform edge deepening processing on each target homogenized block to obtain the corresponding deepened homogenized block, and is also used to fit each deepened homogenized block and each block to be filled to obtain a block fitting image, and outputs the block fitting image; a contour processing device, which is connected to the block deepening device, and is used to receive the block fitting image, and performs binarization processing on the block fitting image to obtain and outputs the corresponding binarized image, for each pixel starting from the top left corner of the binarized image throughout the whole image, if the surrounding pixels with more than 5 points are black level pixels or the surrounding pixels with more than 5 points are white level pixels, then the pixel is used as an internal pixel, otherwise, the pixel is used as a preliminary contour pixel; the contour processing device connects all preliminary contour pixels in the binarized image and performs fitting to obtain a plurality of fitted closed curves, and modifies the preliminary contour pixels outside the fitted closed curve as internal pixels, and the unmodified preliminary contour pixels are regarded as the final contour pixels; a child identification device, which is connected to the contour processing device, and is used to connect all final contour pixels to obtain a plurality of closed regions, determines the area of each closed region, and sends out child identification signal when there is a closed region with an area equal to the preset child area distribution range; wherein, the child identification device is also used to send a child unidentified signal when there is no closed region with an area equal to the preset child area distribution range; wherein, the AC permanent magnet motor is also connected to the child identification device, and is used to automatically shut down when the child identification signal is received, and maintains the current operating mode when the child unidentified signal is received.

More specifically, in the child-proof smart hair dryer: the optical filter is arranged in front of the optical lens, and the image sensing device is arranged in front of the optical lens.

More specifically, in the child-proof smart hair dryer: in the data analysis device, determining the displacement vector of the image to be analyzed relative to the image to be compared based on the overall comparison between the image to be analyzed and the image to be compared, which includes: acquiring each red channel value of each pixel of each of the image to be analyzed and each red channel value of the image to be compared, determining the displacement vector of the image to be analyzed relative to the image to be compared based on each red channel value of each pixel of the image to be analyzed and each red channel value of the image to be compared.

### DESCRIPTION OF ATTACHED FIGURE

The embodiments of the present invention will be described below with reference to the attached figure, wherein:

FIG. 1 is a schematic structural diagram of a child-proof smart hair dryer according to an embodiment of the present invention.

### DETAILED IMPLEMENTATION METHOD

The embodiments of the child-proof smart hair dryer of the present invention will be described in detail below with reference to the attached figure.

A hair dryer is a combination of a set of electric heating wires and a small high-speed fan. When power is connected, the heating wire generates heat, and the wind blown by the fan passes through the heating wire to become hot air. If only a small fan is rotating and the heating wire is not hot, then the wind coming out will not be warm.

Hair dryers are also dangerous, such as when children play with them, or when adults forget to turn them off after use and there are children around.

In order to overcome the above shortcomings, the present invention builds a child-proof smart hair dryer, which can effectively solve the corresponding technical problems.

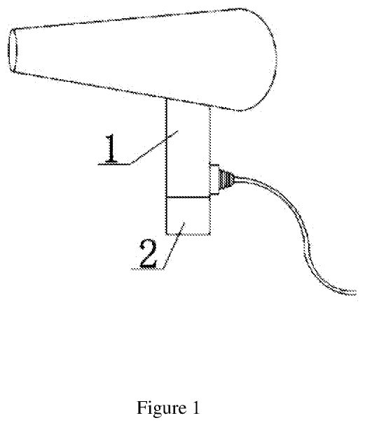

FIG. 1 is a schematic structural diagram of a child-proof smart hair dryer according to an embodiment of the present invention. The hair dryer includes a handle 1 and a power connector 2, and the hair dryer further includes:
an AC permanent magnet motor, used for driving the fan blade structure of the hair dryer to rotate;
the fan blade structure, which is arranged between the air inlet of the hair dryer and the front nozzle of the air duct, for sucking in air from the air inlet while rotating, and forming a centrifugal airflow in the air duct to blow it out through the front nozzle of the air duct;
a hemispherical photographing mechanism, which includes a trailing measurement device, an image capture device, a data analysis device, a DC drive motor, an optical filter, an optical lens, and an image sensing device, wherein the image sensing device is set on the air duct, and is used to take an image of the front of the air duct.

Next, the specific structure of the child-proof smart hair dryer of the present invention will be further described.

The child-proof smart hair dryer further comprises:
a trailing measurement device, which is connected to the image sensing device, and is used to receive the image in front of the air duct, and performs an image content measurement of the image in front of the air duct to determine whether a trailing pattern appears in the image in front of the air duct, and sending a content trailing signal when a trailing pattern appears, or otherwise, sending a content normal signal;
an image capture device, which is respectively connected to the trailing measurement device and the image sensing device, and is used to output the image in front of the air duct corresponding to the first content trailing signal as an image to be analyzed, and outputs the image in front of the air duct closest to the image in front of the air duct corresponding to the first content trailing signal as an image to be compared when the first content trailing signal is received.

The child-proof smart hair dryer further comprises:
a data analysis device, which is connected to the image capture device, and is used to receive the image to be analyzed and the image to be compared, and to determine the displacement vector of the image to be compared relative to the image to be analyzed based on the overall comparison between the image to be analyzed and the image to be compared, and outputs as the current displacement vector.

The child-proof smart hair dryer further comprises:
a DC drive motor, which is respectively connected to the optical filter, the optical lens, the image sensing device and the data analysis device, and is used to control the optical filter, the optical lens and the image sensing device to move together in an opposite direction basing on the displacement vector.

The child-proof smart hair dryer further comprises:
a white balance processing device, which is connected to the hemispherical photographing mechanism, and is used to receive the image in front of the air duct and perform white balance processing on the image in front of the air duct to obtain and outputs a corresponding white balance image;
a morphology processing device, which includes an expansion processing sub-device and a corrosion processing sub-device, wherein the expansion processing sub-device is connected to the white balance processing device, and is used to receive the white balance image and performs expansion processing on the white balance image to obtain a corresponding expansion processing image, and the corrosion processing sub-device is connected to the expansion processing sub-device for receiving the expansion processing image and performing corrosion processing on the expansion processing image to obtain the corresponding corrosion processed image;
a pixel value statistics device, which is connected to the morphology processing device, and is used to receive the corrosion processed image, obtains each brightness value of each pixel of the corrosion processed image, performs a mean square error calculation on each brightness value, and outputs the obtained mean square error value as reference data;
a fragment extraction device, which is connected to the pixel value statistics device, and is used to receive the corrosion processed image and the reference data, and performs uniform segmentation on the corrosion processed image based on the reference data to obtain a plurality of segmented fragments, wherein, the larger the reference data, the larger the number of segmented fragments obtained by uniformly segmenting the corrosion processed image;
a noise analysis device, which is connected to the fragment extraction device, and is used to receive the plurality of segmented fragments, and detects the top five noise types of the segmented fragments in amplitude for each segmented fragment, determines the signal-to-noise ratio of the segmented fragments based on the respective amplitude corresponding to the five noise types, and determines the threshold size for background segmentation of the segmented fragments based on the signal-to-noise ratio of the segmented fragments;
a foreground extraction device, which is connected to the noise analysis device, and is used to perform background segmentation processing on the segmented fragments based on a determined threshold value to obtain the corresponding foreground fragment for each segmented fragment, and to perform fitting on each foreground fragment of each segmented fragment to obtain a foreground detection image, and outputs the foreground detection image;
an edge enhancement device, which is connected to the foreground extraction device, and is used to receive the foreground detection image, and performs edge enhancement processing on the foreground detection image based on the corresponding intensity of the signal-to-noise ratio of the foreground detection image to obtain corresponding adaptive enhanced image, and outputs the adaptive enhanced image;
a block searching device, which is connected to the edge enhancement device, and is used to receive the adaptive enhanced image, and performs homogenized block processing on the adaptive enhanced image to obtain each homogenized block, and performs the following operations to each homogenized block: acquiring the average of the brightness value of each pixel of the homogenized block; the block searching device is further used to determine the average of the image-level brightness of the adaptive enhanced image based on each of the average value of each homogenized block, the homogenized block whose absolute value of the difference between the average value and the image-level brightness average exceeds the limit is used as the target homogenized block, and outputs each target homogenized block in the adaptive enhanced image; in the block searching device, a plurality of homogenized blocks except for each target homogenized block in the adaptive enhanced image are used as a plurality of homogenized blocks to be filled, and outputs the plurality of homogenized blocks to be filled;
a block deepening device, which is connected to the block searching device, and is used to perform edge deepening processing on each target homogenized block to obtain the corresponding deepened homogenized block, and is also used to fit each deepened homogenized block and each block to be filled to obtain a block fitting image, and outputs the block fitting image;
a contour processing device, which is connected to the block deepening device, and is used to receive the block fitting image, and performs binarization processing on the block fitting image to obtain and outputs the corresponding binarized image, for each pixel starting from the top left corner of the binarized image throughout the whole image, if the surrounding pixels with more than 5 points are black level pixels or the surrounding pixels with more than 5 points are white level pixels, then the pixel is used as an internal pixel, otherwise, the pixel is used as a preliminary contour pixel; the contour processing device connects all preliminary contour pixels in the binarized image and performs fitting to obtain a plurality of fitted closed curves, and modifies the preliminary contour pixels outside the fitted closed curve as internal pixels, and the unmodified preliminary contour pixels are regarded as the final contour pixels;
a child identification device, which is connected to the contour processing device, and is used to connect all final contour pixels to obtain a plurality of closed regions, determines the area of each closed region, and sends out child identification signal when there is a closed region with an area equal to the preset child area distribution range;
wherein, the child identification device is also used to send a child unidentified signal when there is no closed region with an area equal to the preset child area distribution range;
wherein, the AC permanent magnet motor is also connected to the child identification device, and is used to automatically shut down when the child identification signal is received, and maintains the current operating mode when the child unidentified signal is received.

In the child-proof smart hair dryer: the optical filter is arranged in front of the optical lens, and the image sensing device is arranged in front of the optical lens.

And, in the child-proof smart hair dryer: in the data analysis device, determining the displacement vector of the image to be analyzed relative to the image to be compared based on the overall comparison between the image to be analyzed and the image to be compared, which includes: acquiring each red channel value of each pixel of each of the image to be analyzed and each red channel value of the image to be compared, determining the displacement vector of the image to be analyzed relative to the image to be compared based on each red channel value of each pixel of the image to be analyzed and each red channel value of the image to be compared.

In addition, the child identification device can be realized by using a CPLD chip. CPLD has the characteristics of flexible programming, high integration, short design and development cycle, wide application range, advanced development tools, low design and manufacturing costs, low hardware experience requirements for designers, no testing is necessary for standard products, strong confidentiality, and affordable prices. Large-scale circuit design can be realized, so it is widely used in product prototype design and product production (generally less than 10,000 pieces). CPLD devices can be used in almost all applications where small and medium-sized general-purpose digital integrated circuits are used. CPLD devices have become an indispensable part of electronic products, and its design and application have become an essential skill for electronic engineers. CPLD is a digital integrated circuit that users construct logic functions according to their needs. The basic design method is to use an integrated development software platform, schematic diagram, hardware description language and other methods to generate the corresponding target file, and transfer the code to the target chip through the download cable (“in-system” programming) to realize the designed digital system.

By adopting the child-proof smart hair dryer of the present invention, in response to the technical problem of the low safety level of hair dryers in the prior art, based on the search results of the blocks with a large content deviation, the obtained blocks are subjected to targeted edge deepening processing, thereby improving the efficiency of edge deepening processing. The oriented and targeted extraction of the foreground image of the image to be processed is realized based on the processing of white balance processing equipment and morphology processing equipment, which provides more valuable data to be analyzed for recognition and detection of subsequent images; when the trailing phenomenon caused by jitter is detected, the image content is analyzed, specifically, the displacement vector of the image is determined based on the red channel value of each pixel of the image, and the built-in motor of hemispherical photographing mechanism is used to perform the corresponding displacement correction. On the basis of the above-mentioned high-precision data processing, when the presence of a child is detected, the AC permanent magnet motor of the hair dryer is turned off in time to avoid related accidents, thereby solving the above technical problems.

It can be understood that although the present invention has been disclosed as above in preferred embodiments, the above-mentioned embodiments are not intended to limit the present invention. For any person skilled in the art, the technical content disclosed above can be used to make many possible changes and modifications to the technical solution of the present invention, or modified with equivalent changes into embodiments of equal efficacies, etc. without departing from the scope of the technical solution of the present invention. Therefore, any simple modifications, equivalent changes and modifications made to the above embodiments based on the technical essence of the present invention without departing from the technical solutions of the present invention still fall within the protection scope of the technical solutions of the present invention.

1-7. (canceled)

8. A child-proof smart hair dryer, characterized in that, the hair dryer comprises:
an AC permanent magnet motor, used for driving the fan blade structure of the hair dryer to rotate;
the fan blade structure, which is arranged between the air inlet of the hair dryer and the front nozzle of the air duct, for sucking in air from the air inlet while rotating, and forming a centrifugal airflow in the air duct to blow it out through the front nozzle of the air duct;
a hemispherical photographing mechanism, which includes a trailing measurement device, an image capture device, a data analysis device, a DC drive motor, an optical filter, an optical lens, and an image sensing device, wherein the image sensing device is set on the air duct, and is used to take an image of the front of the air duct.
characterized in that, the hair dryer further comprises:
a trailing measurement device, which is connected to the image sensing device, and is used to receive the image in front of the air duct, and performs an image content measurement of the image in front of the air duct to determine whether a trailing pattern appears in the image in front of the air duct, and sending a content trailing signal when a trailing pattern appears, or otherwise, sending a content normal signal;
an image capture device, which is respectively connected to the trailing measurement device and the image sensing device, and is used to output the image in front of the air duct corresponding to the first content trailing signal as an image to be analyzed, and outputs the image in front of the air duct closest to the image in front of the air duct corresponding to the first content trailing signal as an image to be compared when the first content trailing signal is received.
characterized in that, the hair dryer further comprises:
a data analysis device, which is connected to the image capture device, and is used to receive the image to be analyzed and the image to be compared, and to determine the displacement vector of the image to be compared relative to the image to be analyzed based on the overall comparison between the image to be analyzed and the image to be compared, and outputs as the current displacement vector.
characterized in that, the hair dryer further comprises:
a DC drive motor, which is respectively connected to the optical filter, the optical lens, the image sensing device and the data analysis device, and is used to control the optical filter, the optical lens and the image sensing device to move together in an opposite direction basing on the displacement vector.
characterized in that, the hair dryer further comprises:
a white balance processing device, which is connected to the hemispherical photographing mechanism, and is used to receive the image in front of the air duct and performs white balance processing on the image in front of the air duct to obtain and outputs a corresponding white balance image;
a morphology processing device, which includes an expansion processing sub-device and a corrosion processing sub-device, wherein the expansion processing sub-device is connected to the white balance processing device, and is used to receive the white balance image and perform expansion processing on the white balance image to obtain a corresponding expansion processing image, and the corrosion processing sub-device is connected to the expansion processing sub-device for receiving the expansion processing image and performing corrosion processing on the expansion processing image to obtain the corresponding corrosion processed image;
a pixel value statistics device, which is connected to the morphology processing device, and is used to receive the corrosion processed image, obtains each brightness value of each pixel of the corrosion processed image, performs a mean square error calculation on each brightness value, and outputs the obtained mean square error value as reference data;
a fragment extraction device, which is connected to the pixel value statistics device, and is used to receive the corrosion processed image and the reference data, and performs uniform segmentation on the corrosion processed image based on the reference data to obtain a plurality of segmented fragments, wherein, the larger the reference data, the larger the number of segmented fragments obtained by uniformly segmenting the corrosion processed image;
a noise analysis device, which is connected to the fragment extraction device, and is used to receive the plurality of segmented fragments, and detects the top five noise types of the segmented fragments in amplitude for each segmented fragment, determines the signal-to-noise ratio of the segmented fragments based on the respective amplitude corresponding to the five noise types, and determines the threshold size for background segmentation of the segmented fragments based on the signal-to-noise ratio of the segmented fragments;
a foreground extraction device, which is connected to the noise analysis device, and is used to perform background segmentation processing on the segmented fragments based on a determined threshold value to obtain the corresponding foreground fragment for each segmented fragment, and to perform fitting on each foreground fragment of each segmented fragment to obtain a foreground detection image, and outputs the foreground detection image;
an edge enhancement device, which is connected to the foreground extraction device, and is used to receive the foreground detection image, and performs edge enhancement processing on the foreground detection image based on the corresponding intensity of the signal-to-noise ratio of the foreground detection image to obtain corresponding adaptive enhanced image, and outputs the adaptive enhanced image;
a block searching device, which is connected to the edge enhancement device, and is used to receive the adaptive enhanced image, and performs homogenized block processing on the adaptive enhanced image to obtain each homogenized block, and performs the following operations to each homogenized block: acquiring the average of the brightness value of each pixel of the homogenized block; the block searching device is further used to determine the average of the image-level brightness of the adaptive enhanced image based on each of the average value of each homogenized block, the homogenized block whose absolute value of the difference between the average value and the image-level brightness average exceeds the limit is used as the target homogenized block, and outputs each target homogenized block in the adaptive enhanced image; in the block searching device, a plurality of homogenized blocks except for each target homogenized block in the adaptive enhanced image are used as a plurality of homogenized blocks to be filled, and outputs the plurality of homogenized blocks to be filled;
a block deepening device, which is connected to the block searching device, and is used to perform edge deepening processing on each target homogenized block to obtain the corresponding deepened homogenized block, and is also used to fit each deepened homogenized block and each block to be filled to obtain a block fitting image, and outputs the block fitting image;
a contour processing device, which is connected to the block deepening device, and is used to receive the block fitting image, and performs binarization processing on the block fitting image to obtain and outputs the corresponding binarized image, for each pixel starting from the top left corner of the binarized image throughout the whole image, if the surrounding pixels with more than 5 points are black level pixels or the surrounding pixels with more than 5 points are white level pixels, then the pixel is used as an internal pixel, otherwise, the pixel is used as a preliminary contour pixel; the contour processing device connects all preliminary contour pixels in the binarized image and performs fitting to obtain a plurality of fitted closed curves, and modifies the preliminary contour pixels outside the fitted closed curve as internal pixels, and the unmodified preliminary contour pixels are regarded as the final contour pixels;
a child identification device, which is connected to the contour processing device, and is used to connect all final contour pixels to obtain a plurality of closed regions, determines the area of each closed region, and sends out child identification signal when there is a closed region with an area equal to the preset child area distribution range;
wherein, the child identification device is also used to send a child unidentified signal when there is no closed region with an area equal to the preset child area distribution range;
wherein, the AC permanent magnet motor is also connected to the child identification device, and is used to automatically shut down when the child identification signal is received, and maintains the current operating mode when the child unidentified signal is received.

9. The child-proof smart hair dryer of claim 8, characterized in that:
the optical filter is arranged in front of the optical lens, and the image sensing device is arranged in front of the optical lens.

10. The child-proof smart hair dryer of claim 9, characterized in that:
in the data analysis device, determining the displacement vector of the image to be analyzed relative to the image to be compared based on the overall comparison between the image to be analyzed and the image to be compared, which includes: acquiring each red channel value of each pixel of each of the image to be analyzed and each red channel value of the image to be compared, determining the displacement vector of the image to be analyzed relative to the image to be compared based on each red channel value of each pixel of the image to be analyzed and each red channel value of the image to be compared.
